(19) United States
(12) Patent Application Publication
(10) Pub. No.: US 2004/0058265 A1
(43) Pub. Date: Mar. 25, 2004

(54) Electrostatic charge image developing developer and image forming apparatus using the same

(75) Inventors: Tsuneaki Kawanishi, (US); Junji Kobayashi, (US); Ryuuichi Shimizu, (US); Shigenori Yaguchi, (US)

Correspondence Address: McGinn & Gibb, PLLC, Suite 200, 8321 Old Courthouse Road, Vienna, VA, 22182-3817, US

(73) Assignee: Hitachi Printing Solutions, Ltd., Ebina-City (JP)

(21) Appl. No.: 10/664,077

(22) Filed: Sep. 17, 2003

(30) Foreign Application Priority Data
Sep. 20, 2002 (JP) P _ 2002-275452

(51) Int. Cl. G03G 9/08

(52) U.S. Cl. 430/108.8; 430/111.41; 430/109.3

(57) ABSTRACT

In an electrostatic charge image developing toner that contains a hydrocarbon wax whose crystallinity is less than 93%, an amount of maximum change in a quantity of charge of the toner is smaller than 20 μC/g and an amount of contamination of a carrier by the toner is less than 0.4 wt % when a developer which is formed by mixing the toner into the carrier is stirred for 24 hours at an atmospheric temperature that is lower than a glass transition point of the toner and is higher than 45 ° C.

### BACKGROUND OF THE INVENTION

1. Field of the Invention

The present invention relates to an electrostatic charge image developing developer used to visualize an electrostatic charge latent image, which is formed by using the electrophotography method, the electrostatic printing method, the electrostatic recording method, or the like, and an image forming apparatus using the same.

1. Background Art

In the electrophotography method, for example, out of the electrophotography method, the electrostatic printing method, and the electrostatic recording method, the recording image is obtained by forming an electrostatic charge latent image on the photoconductive photoreceptor by charging/exposing a surface of the photoreceptor as the electrostatic charge bearing member, then developing the electrostatic charge latent image by using the fine grain toner that contains the coloring agent, etc. in the resin as the binder, and then transferring/fixing the resultant toner image onto the recording medium such as the paper, or the like.

In such electrostatic image recording steps, development of the electrostatic charge latent image by the fine grain toner and fixing of the image onto the recording medium are particularly important steps. As the developing method, the magnetic brush developing method employing the two component developer consisting of the toner, which makes the high-speed and high-picture quality development possible, and the magnetic carrier is often used. Also, as the fixing method, the heat roller fusing method, which has a high thermal efficiency and makes the high-speed fixing possible, is often used.

Meanwhile, recently the laser beam printer that uses the laser beam to expose the photoconductive photoreceptor and reproduces the recorded image by dots in compliance with the modulation signal, which is generated based on the instruction issued from the computer, is developed with the progress of the information equipments. In particular, since the higher picture quality in the image recording is required of the recent laser beam printer, the diameter of the laser beam is narrowed down and thus the dot density is increased like 600 to 1200 dpi (dots/inch). According to this, particle sizes of the toner and the carrier are made small for the purpose of developing the fine electrostatic charge latent image. Thus, the application of the fine grain toner whose volume-average particle size is 10 μm or less and the fine grain carrier whose weight-average particle size is 100 μm or less is advanced.

By the way, the above heat roller fusing is often used in the fixing. In this case, the consumption power of the fixing heater and the driving motor must be lowered from viewpoints such as prevention of thermal degradation of the parts in the apparatus by suppressing the superheat degradation of the printer, shortening of a warm-up time required until the fixing operation can be carried out after the fixing unit is operated, maintenance of the picture quality during the continuous paper feeding by preventing the incomplete fixing because the heat is absorbed by the recording medium, prevention of the curl of the recording medium and the fire due to the superheat, simplification and size reduction of the configuration of the fixing unit by reducing the load applied to the heat roller, etc. Thus, the development of the toner that is able to fix the image at a lower temperature of the heat roller and a lower pressure of the heat roller is desired. As described above, the development of the high performance toner that can fix the image at the low temperature and the low pressure by using the fine particles is desired.

Meanwhile, as described above, if the size of the toner is reduced to the fine grain of 10 μm or less, following problems are caused. In other words, if the fine grain toner is used in the developing step, the high picture quality can be obtained, but the adhesion (fog) of the toner onto the non-image portion and the scattering of the toner are easily caused and also the handling properties such as the toner transfer, etc. are easily lowered because of the reduction in the fluidity.

In addition, because of the strength of the adhesion force and the weakness of the impact resistance of the fine grain toner, the carrier contamination due to the toner is easily caused and thus the life of the developer is easily lowered.

Also, an energy that is larger than that required for the toner with a large particle size is needed in the fixing to get the same fixing strength, and yield of the classifying step is lowered at the time of manufacturing the toner. Thus, a cost of the toner is raised. These many problems are caused by the fine grain toner. Normally it is difficult to put the toner with a size of 5 μm or less into practical use. Therefore, the average particle size of the toner is classified in the range of 6 μm to 10 μm, and then the fluidity of the toner in use is enhanced by the external additive of the toner and improvement in the externally adding prescription. In contrast, with the reduction in the particle size of the toner, the frictional charging property of the carrier to the toner is improved by setting the weight-average particle size to the small particle size of 100 μm or less and also increasing the specific surface area of the carrier. However, in the carrier having the size of 30 μm or less, a magnetic force of the carrier is lowered and the carrier is adhered easily on the electrostatic charge bearing member by the electrostatic attractive force. Therefore, the average particle size of the carrier is classified in the range of 30 μm to 100 μm, and then a surface of the carrier is coated with a resin as the case may be.

Because of the improvement of the particle size distribution and improvements of the fluidity and the electrostatic property, the fine grain toner and the developer can be practically used in the image forming apparatus that is typified by the copying machine or the printer. However, if the high-speed printing in excess of 10 pages per minute is repeated, the problem peculiar to the fine grain toner is caused and reduction in the life of the developer due to the carrier contamination by the toner is easily caused. Also, it is hard to attain the fixing strength of the image, and thus the temperature and the pressure of the heat roller must be enhanced particularly in the fixing step. Therefore, there is such a problem that it is difficult to achieve the higher reliability, the simplification and the reduction in size, and the reduction in cost of the fixing unit.

It is publicly known in JP-A-52-3304, JP-A-52-3305, and JP-A-57-52574, etc., for example, that the wax should be added to the fixing resin to improve the fixing performance of the toner. The wax, and the like are employed to improve the fixing property of the toner at the time of low temperature by preventing the adhesion of the toner onto the heat roller at the time of low temperature or high temperature, i.e., the so-called offset phenomenon. In recent, the low-melting wax is watched with interest from the viewpoint of the low-temperature fixing.

It is disclosed in JP-A-5-313413, for example, that, in order to improve the low-temperature fixing property, the offset resistance, and the non-aggregation property of the toner, the ethylene or propylene whose viscosity at 140° C. is one ten thousand poise or less and the α-olefin copolymer should be added to the vinyl copolymer that has a particular molecular weight distribution.

Also, for the similar purpose, it is disclosed in JP-A-7-287413 that the paraffin wax whose peak (melting point) of the absorbed heat quantity measured by the differential scanning calorimeter (DSC) is at 75° C. to 85° C. should be added. Also, it is disclosed in JP-A-8-314181, JP-A-9-179335, and JP-A-9-319139 that the natural gas Fischer-Tropsch wax whose melting point measured by the DSC is at 85° C. to 100° C. should be added. Also, it is disclosed in JP-A-6-324513 that the polyethylene wax whose melting point measured by the DSC is at 85° C. to 110° C. should be added.

Also, it is disclosed in JP-A-7-36218 that the polyethylene wax whose melting point measured by the DSC is set in the range of 70° C. to 120° C. by removing the component whose melting point is set to 50° C. or less by virtue of the distillation process, or the like should be added. In addition, it is disclosed in JP-A-11-114942 that the polyethylene wax whose weight-average molecular weight (Mw) is below one thousand should be added.

By the way, if the low-melting wax is added to the toner, the heat resistance and the durability of the toner are lowered. In order to improve this, it is disclosed in JP-A-6-123994 that the wax whose ratio of weight-average molecular weight/number-average molecular weight (Mw/Mn) is 1.5 or less should be used, it is disclosed in JP-A-7-209909 that the ethylene olefin polymer wax whose melt viscosity at 140° C. is 0.5 mpa·s to 10 mPa·s and whose penetration is 3.0 dmm or less should be used, and it is disclosed in JP-A-7-287418 that the Fischer-Tropsch wax whose average molecular weight is one thousand or more should be used.

It is possible to improve the fixing performance of the toner by using the above prior art. However, if the low-melting wax is employed, it is difficult particularly to improve the fixing performance of the fine grain toner while maintaining the heat resistance and the durability of the toner. Thus, it is impossible to provide a toner that can be put into practical use, and an image forming apparatus.

### SUMMARY OF THE INVENTION

It is an object of the present invention to provide a toner that is excellent in the heat resistance and the durability and is capable of reducing an energy required for the fixing, and an image forming apparatus using the same.

To achieve the object, the invention provides an electrostatic charge image developing developer, including: a carrier; and an electrostatic charge image developing toner including a fixing resin and a hydrocarbon wax whose crystallinity is less than 93%, the electrostatic charge image developing toner being mixed into the carrier; wherein an amount of maximum change in a quantity of charge of the electrostatic charge image developing toner is smaller than 20 μC/g, and an amount of contamination of a carrier due to the electrostatic charge image developing toner is less than 0.4 wt %, when the electrostatic charge image developing developer is stirred for 24 hours at an atmospheric temperature that is lower than a glass transition point of the toner and is higher than 45° C.

The invention may provide an image forming apparatus including: an electrostatic charge bearing member that bears an electrostatic charge latent image thereon; a developing unit for supplying an electrostatic charge image developing developer to the electrostatic charge bearing member to visualize the electrostatic charge latent image as a toner image; a transferring unit for transferring the toner image formed on the electrostatic charge bearing member onto a recording medium; and a fixing unit for fixing the toner image onto the recording medium by applying at least a heat to the recording medium that bears the toner image; wherein the electrostatic charge image developing developer is formed by mixing an electrostatic charge image developing toner that contains at least a fixing resin and a hydrocarbon wax whose crystallinity is less than 93% into a carrier; when the electrostatic charge image developing developer is stirred for 24 hours at an atmospheric temperature that is lower than a glass transition point of the toner and is higher than 45° C., an amount of maximum change in a quantity of charge of the electrostatic charge image developing toner is smaller than 20 μC/g and an amount of contamination of the carrier due to the electrostatic charge image developing toner less than 0.4 wt %.

### BRIEF DESCRIPTION OF THE DRAWINGS

The present invention may be more readily described with reference to the accompanying drawings:

FIG. 1 is an absorbed heat quantity curve in DSC.

FIG. 2 is an overall configurative view of a laser beam printer to which the present invention is applied.

### DETAILED DESCRIPTION OF THE PREFERRED EMBODIMENTS

Embodiments of the present invention will be explained in detail hereinafter. Normally, as the fixing resin of the toner, the styrene-(meta)acryl resin or the polyester resin is employed in the heat roller fusing. Normally the polyester resin has the polar groups with the high moisture-absorbing property (the hydroxyl group, the carboxyl group). Thus, there are such tendencies that, since the toner is ready to absorb the moisture, the charging characteristic of the toner is ready to change. In recent, the resin having the low hydroscopic property in which the styrene-acryl is mixed in the polyester resin by the graft copolymerization was developed. The fixing performance of the toner can be improved by adding the wax, or the like into these fixing resins.

Normally the wax, or the like is used for long as the offset preventing agent of the toner. In contrast, there are such problems that the heat resistance and the durability of the toner are lowered and the fusion is ready to occur. There are a wide variety of waxes, and they are used properly according to their functions. In this case, it is preferable from an aspect of preventing the offset of the toner that the hydrocarbon wax that is nonpolar and has the non-adhesive property to the heat roller should be used.

The hydrocarbon wax is the aggregate of hydrocarbon molecules having a molecular weight distribution, and the characteristic of the hydrocarbon wax depends largely on the molecular weight distribution. Normally the hydrocarbon wax produces an effect of preventing the high-temperature offset, and also produces effects of preventing the low-temperature offset and the improvement of the low-temperature fixing by increasing low molecular weight components.

However, if the low molecular weight components are increased to improve the fixing performance, the heat resistance and the durability are lowered and thus the fusion of the developer into the carrier is easily caused. Hence, the optimization of the molecular weight distribution is tried by cutting the low molecular weight components of the existing hydrocarbon wax. More particularly, in JP-A-6-123994, in the molecular weight distribution that is measured by the gel permeation chromatography (GPC), the molecular weight distribution of the wax is sharpened such that the ratio of weight-average molecular weight/number-average molecular weight (Mw/Mn) is set to 1.5 or less, preferably 1.45 or less.

However, according to the study of the inventors of this application, it was found that, if the molecular weight distribution of the hydrocarbon wax is sharpened as described above, the heat resistance and the durability are improved but the fixing performance becomes insufficient, particularly the fixing performance is lowered when the high-speed printing in excess of 10 pages per minute is repeated.

Therefore, the inventors of this application apply the hydrocarbon wax, whose the molecular weight distribution is rationalized by containing appropriately the low molecular weight components, to the toner. As the result of the evaluation of various characteristics, it was found that, if the crystallinity being measured by the X-ray diffraction method is less than 93% and also the melting point defined as the maximum peak of the absorbed heat quantity curve at the time of temperature rise is set in the range of 50° C. to 120° C. in the DSC curve measured by the differential scanning calorimeter, the fixing performance of the toner can be obtained sufficiently.

Here, there is a correlation between the crystallinity of the hydrocarbon wax and the molecular weight distribution of the wax. There is such a tendency that, if the crystallinity becomes large, the molecular weight distribution becomes small. According to the study of the inventors of this application, if the crystallinity of the hydrocarbon wax is increased to exceed the above range, the molecular weight distribution of the wax is reduced and thus the low molecular weight components are reduced. Therefore, the sufficient fixing property and the offset resistance property cannot be implemented in the high-speed printing using the fine grain toner. Also, the melting point of the wax by the DSC must be specified in the range of 50° C. to 120° C. The fusing property of the toner is increased and thus the high-temperature offset is ready to occur if the melting point of the wax is below 50° C. whereas the fixing property of the toner is lowered if the melting point of the wax is in excess of 120° C. In other words, if the hydrocarbon wax having the crystallinity and the melting point in the range in the present invention is added appropriately to the fixing resin, the sufficient fixing performance can be obtained.

However, since the hydrocarbon wax of the present invention has the small crystallinity and the low melting point, the heat resistance and the durability of the toner are easily lowered, and thus reduction in the developer life due to the carrier contamination caused by the toner is easily caused. In order to prevent this, the developer in which the toner and the carrier are mixed is prepared as the developer in which an amount of maximum change in a quantity of charge of the toner is smaller than 20 μC/g and an amount of contamination of the carrier due to the toner is less than 0.4 wt %, when the electrostatic charge image developing developer is stirred for 24 hours at an atmospheric temperature that is lower than a glass transition point of the toner and is higher than 45° C. and thus recording/formation of the stable electrostatic toner image can be implemented. For this purpose, an addition amount, the adding method, etc. of the wax must be thought out when the wax of the present invention is added to the toner.

In the toner of the present invention, the addition amount of the hydrocarbon wax can be set in the range of 0.5 to 10 wt % with respect to a total amount of the fixing resin and the wax. More preferably, the wax should be added in the range of 3.0 to 6.0 wt %. An effect of improving the fixing performance of the toner is reduced if the addition amount of the wax is below 0.5 wt %, while the high-temperature offset of the toner is easily caused if the addition amount of the wax is in excess of 10 wt %. In addition, the hydrocarbon wax of the present invention may be used together with other waxes, but a care must be taken not to spoil the performance of the hydrocarbon wax of the present invention.

If the dispersibility of the wax into the toner is improved and the dispersed particle size is reduced, the heat resistance and the durability of the toner can be improved. As the measure for this, there is the method of increasing an energy required at the time of thermally melting/kneading the toner to increase the miscibility of the wax and the fixing resin. However, according to this method, if the energy enough to improve the dispersibility of the wax is applied to the fixing resin, the fixing resin is subjected to the mechanical damage and also the fixing property and the high-temperature offset resistance are readily lowered.

Therefore, as another measure of improving the dispersibility of the wax, the concomitant polymerizing method in which the wax exists together in a part or all of synthesizing steps applied to synthesize the fixing resin was studied. At that time, the wax could be dispersed uniformly into the fixing resin without degradation of the resin. Also, it was found that, when the fixing resin obtained by the above method is applied to the toner, the heat resistance and the durability of the toner can be improved and thus degradation of the developer due to the carrier contamination caused by the toner can be reduced.

If the developer, in which an amount of maximum change in a quantity of charge of the toner is smaller than 20 μC/g and an amount of contamination of the carrier due to the toner is less than 0.4 wt % when the developer which is formed by mixing the toner containing the wax of the present invention into the carrier is stirred for 24 hours at an atmospheric temperature that is lower than a glass transition point of the toner and is higher than 45° C., is prepared by using these methods, the recording/formation of the stable electrostatic toner image whose degradation of the picture quality is small can be implemented.

In the present invention, the hydrocarbon wax that is nonpolar and is not adhered to the heat roller is most suitable. The hydrocarbon wax can be obtained from the natural wax or the synthetic wax, and is the aggregate of the hydrocarbon molecules having the molecular weight distribution. There are animal/plant wax, mineral wax, and petroleum wax as the natural wax. There are Fischer-Tropsch wax, polyethylene wax, etc. as the synthetic wax. The hydrocarbon wax having the melting point and the crystallinity of the present invention is selected appropriately from these waxes and is used. Out of the synthetic waxes, the polyethylene wax is the low polymerized substance of polyethylene that is obtained industrially by the medium-pressure or low-pressure polyethylene polymerizing process using the Ziegler catalyst or the metallocene catalyst. This low polymerized substance of polyethylene is refined and then used. In other words, the wax of the present invention can be obtained by removing the oil component, the oligomer, etc. from this low polymerized substance of polyethylene by virtue of the vacuum distillation method, or the like, and then removing the low molecular weight components from the resultant distillated residual liquid at the high temperature and the highly lowered pressure as the case may be.

In the present invention, the crystallinity of the wax is measured by the X-ray diffraction method under following conditions.

X rays: Cu—Kα beam (monochromized by the graphite monochromator)

Wavelength λ=1.5406 Å

Outputs: 40 kV, 40 mA

Optical system: reflection method, slit DS,SS=1°, RS=0.3 mm

Measured range: 2θ=10° to 35°

Step interval: 0.02°

Scanning rate: 2θ/θ continuous scan 1.00°/min

The measurement was carried out, then the X-ray diffraction profile of the sample was separated into three crystal peaks and the noncrystalline scattering, and then the crystallinity was calculated by a following equation based on these areas.

Crystallinity (%)=Ic/(Ic+Ia)×100

Ic: sum of respective crystal peak areas

Ia: sum of respective crystal peak areas+noncrystalline scattering area

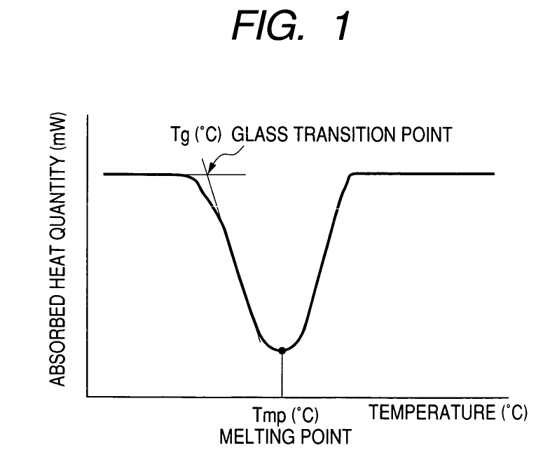

Also, since the heat exchange in the wax is measured in the DSC measurement to observe its behavior, it is preferable that the measurement should be executed by using the high-precision heat flux type differential scanning calorimeter in view of the measuring principle. For example, 2910 manufactured by TA instrument Co., Ltd. may be employed. As the measuring conditions, the wax is weighed by about 5 mg and loaded into the DSC, then the temperature is risen from about 20°C. to 200° C. while flowing a nitrogen gas into an inside at a rate of 50 ml/min, then the temperature is lowered from 200° C. to about 20° C. at a rate of about 10° C./min to get the prehistory, then the temperature is risen once again at a rate of 10° C./min, and then the melting point (Tmp in FIG. 1) that corresponds to the maximum value of the absorbed heat peak of the wax is calculated based on the maximum peak in the DSC absorbed heat quantity curve shown in FIG. 1 at that time. In contrast, the glass transition point of the toner can be detected by measuring the absorbed heat quantity curve similarly in the above DSC measurement and then detecting a shoulder (Tg in FIG. 1) of the absorbed heat quantity curve, which is caused by the fixing resin.

As other physical property of the hydrocarbon wax, it is desired that the penetration measured at 25° C. should be set as small as possible. In the present invention, since the low molecular weigh components are contained appropriately in the wax having the small crystallinity, the penetration measured based on JIS-K-2207 is given as 1 to 10 dmm.

In the present invention, the addition amount and the adding method of the wax must be set properly to get the heat resistance and the durability of the toner. As to the developer in which the toner and the carrier are mixed, a relationship between change of the physical property and degradation of the picture quality was examined. As a result, it was found that, when the developer is stirred for 24 hours at an atmospheric temperature that is lower than a glass transition point of the toner and is higher than 45° C., there is a strong correlation between the physical properties of the toner and the degradation of the picture quality and that, if an amount of maximum change in a quantity of charge of a toner is smaller than 20 μC/g and an amount of contamination of a carrier due to the toner is less than 0.4 wt % in the above stirring, the degradation of the picture quality due to the long-term printing of the developer is hard to occur.

In the present invention, the durability of the toner is evaluated by applying the stress to the developer that is prepared by mixing the toner with the carrier. At that time, the load applied to the toner is changed minutely according to a mixed rate of the toner and the carrier, mixing/stirring conditions, material of the carriers etc.

In the present invention, the magnetite carrier on the surface of which the resin is coated by an appropriate amount and which has a particle size of about 90 μm was employed, and the mixed rate of the toner and the carrier was set to about 2.5 wt %, and the developer of about 1 kg was prepared by the mixer. Then, the developer was filled into the small one roller developer of the magnetic roller fixed type, then the developer was stirred while setting a roller diameter of about 30 mm, a roller peripheral speed of about 1400 mm/sec and a regulating gap of the developer of about 0.6 mm without the supply of the toner during the stirring, then the developer is held appropriately while controlling the atmospheric temperature to the temperature that is lower than the glass transition point of the toner and is higher than 45° C. until 24 hours has lapsed after the start of the stirring, and then change in the physical properties of the developer was examined by sampling the developer at every 4 hours, for example.

As the physical properties of the developer, a quantity of charge of the toner was measured by the charge quantity measuring equipment using the Faraday cage, and an amount of carrier contamination was measured by the wet method (the method of detecting weight % of the toner that is adhered to the carrier to the carrier that is contaminated by the toner by removing the toner from, the carrier by virtue of the rinsing to separate the carrier contaminated by the toner, and then solvent-eluting or burning the toner adhered to the carrier to remove the toner).

In the present intention, the atmospheric temperature at which the developer is stirred is set to the temperature that is lower than the glass transition point of the toner and is higher than 45° C. In the wax of the present invention, it is estimated that the heat absorption in the DSC is observed in this temperature range and the molecule motion is started. Therefore, the strength of the wax that appeared on the surface of the toner is lowered, and thus the durability of the toner is lowered. This makes it possible to execute the accelerated degradation test of the toner, and a quantity of charge of the toner and an amount or contamination of the carrier by the toner are increased with the lapse of the stirring time. This is because the external additive such as the externally added silica, etc. is buried under the surface of the toner due to the reduction in the strength of the surface of the toner to enhance a quantity of charge of the toner, and also the toner that is worn away from the surface of the toner is adhered onto the surface of the carrier and thus an amount of contamination by such adhesion is increased gradually. In the present invention, the relationships between these degradation factors and the picture quality were studied. As a result, it was found that, if changes of the physical properties exhibiting the degradation are suppressed within the range of the present invention, the degradation of the picture quality due to the long-termprinting of the developer is hard to occur.

As the fixing resin employed in the toner of the present invention, for example, resins may be listed as follows. There are listed homopolymer of styrene or its substitution product such as polystyrene, poly-p-chlorstyrene, polyvinyltoluene, etc.; styrene copolymer such as styrene-p-chlorstyrene copolymer, styrene-vinyltoluene copolymer, styrene-vinylnaphthalene copolymer, styrene-acrylate copolymer, styrene-methacrylate copolymer, styrene-α-methyl chlormethacrylater copolymer, styrene-acrylonitrile copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-acrylonitrile-indene copolymer, etc.; and poly(vinyl chroride), phenol resin, natural modified phenol resin, natural resin modified maleate resin, acrylic resin, methacrylic resin, polyvinyl acetate), silicon resin, polyester resin, polyurethane, polyamide resin, furan resin, epoxy resin, xylene resin, polyvinyl butyral, terpene resin, chroman-indene resin, petroleum resin, etc. Preferably, styrene copolymer or polyester resin may be employed. Also, the resin having the low hydroscopic property, which is formed by mixing styrene-acryl into the above polyester resin by the graft copolymerization, may be employed. In this case, styrene polymer or styrene copolymer may be bridged, and also mixed resin may be employed.

The vinyl copolymer employed in the fixing resin of the present invention may contain the styrene monomer and/or the (meta) acrylate monomer as the constitutive unit. Also, the vinyl copolymer can contain the vinyl monomer except the above monomers.

As examples of the styrene monomer in the present invention, o-methlstyrene, m-methlstyrene, p-methlstyrene, α-methlstyrene, p-ethlstyrene, 2,4-dimethlstyrene, p-n-butylstyrene, p-ter-butylstyrens, p-n-hexylstyrene, p-n-octylstyrene, p-n-dodecylstyrene, p-methoxystyrene, p-phenylstyrene, p-chlorstyrene, 3,4-dichlorstyrene, etc. may be listed in addition to the styrene.

As examples of the acrylate or methacrylate monomer in the present invention, 2-chlorethyl acrylate, phenyl acrylate, metyl α-chloracrylate, phenyl methacrylate, dimethylaminoethyl methacrylate, diethylaminoethyl methacrylate, 2-hydroxyethyl methacrylate, glycidyl methacrylate, bisglycidyl methacrylate, polyethylene glycol demethacrylate, methacryloxy ethyl phosphate, etc. may be listed in addition to alkylester acrylate or methacrylate such as methyl acrylate, ethyl acrylate, propyl acrylate, n-butyl acrylate, isobutyl acrylate, n-octyl acrylate, dodecyl acrylate, 2-ethylhexyl acrylate, stearyl acrylate, methyl methacrylate, ethylmethacrylate, propylmethacrylate, n-butyl methacrylate, isobutyl methacrylate, n-octyl methacrylate, dodecyl methacrylate, stearyl methacrylate, etc. In particular, ethyl acrylate, propyl acrylate, butyl acrylate, methyl methacrylate, ethyl methacrylate, propyl methacrylate, butyl methacrylate, etc. should be preferably employed.

As other vinyl monomers in the present invention, acrylic acid such as acrylic acid, methacrylic acid, α-ethylacrylic acid, crotonic acid, eta. and their α- or β-alkyl derivative, unsaturated dicarboxylic acid such as fumaric acid, maleicacid, citraconic acid, itaconic acid, etc., and their monoester derivative and diester derivative, monoacryloyloxyethyl ester succinate, monomethacryloyloxyethyl ester succinate, acrylonitrile, methacrylonitrile, acrylamide, etc. may be listed.

The fixing resin in the present invention can be obtained to contain at least the vinylcopolymer, in which the wax is dispersed uniformly, as the constitutive element by executing the concomitant polymerization, which makes it possible to exist the wax of the present invention together, as a part or all of synthesizing steps while using these vinyl monomers. In this case, the vinylcopolymer may be bridged partially by the crosslinking agent made of the monomer, which has two polymeric double bonds or more mainly, e.g., divinylbenzene, divinylnapthalene, ethylene glycol dimethacrylate, 1,3-butanediol dimethacrylate, divinylaniline, divinylether, divinylsulfide, divinylsulfone, etc.

If the charging controlling agent is blended (internally added) or mixed (externally added) into toner particles of the toner of the present invention, a quantity of charge of the toner can be controlled at a desired value.

As the positive charging controlling agent of the toner, denaturated substance made of nigrosine and fatty acid metal salt, etc.; tributylbenzyl ammonium-1-hydroxy-4-naphthosulfonic acid, quaternary ammonium salt such as tetrabutyl ammonium tetrafluoroborate, and onium salt such as phosphonium salt as these analogs, etc. and these lake pigments, triphenylmethane dye and these lake pigments, metal salt of higher fatty acid; diorgano tin oxide such as dibutyl tin oxide, dioctyl tin oxide, dicyclohexyl tin oxide, etc.; diorgano tin borate such as dibutyl tin borate, dioctyl tin borate, dicyclohexyl tin borate, etc.; and the combination of two above substances or more may be employed. In particular, preferably the charging controlling agent such as the nigrosine, the quaternary ammonium salt, the triphenylmethane dye among them should be employed.

As the negative charging controlling agent of the toner, organic metal complex and chelate compound are effective, and there are monoazo metal complex, acetylacetone metal complex, and metal complex of aromatic hydroxycarboxylic acid or aromatic dicarboxylic acid. In addition, there are aromatic hydroxycarboxylic acid, aromatic mono and polycarboxylic acid and their metal salt, anhydride, ester, phenol derivative such as bisphenol.

It is preferable that, if these charging controlling agents are internally added to the toner, such agents should be added by 0.1 to 10 wt % of the fixing resin.

It is preferable that, in order to improve the developing property, the fluidity, and the durability, silica impalpable powders should be externally added to the toner of the present invention. The silica impalpable powders each having a specific surface area of 10 m²/g or more due to the nitrogen adsorption measured by the BET method are preferable, and such silica impalpable powders are externally added in the range of 0.01 wt % to 5 wt % of the toner. Also, the silica impalpable powders are employed by applying the hydrophobization or controlling the charging property while using the treating agent such as organic silicon compound, or the like or various treating agents, as the case may be.

In addition, as other additive of the toner, lubricant powders such as Teflon (trademark) resin powders, zinc stearate powders, poly(vinylidene fluoride) powders, for example, are employed, and especially poly(vinylidene fluoride) powders are preferable. Otherwise, the abrasive such as cerium oxide powders, silicon carbide powders, strontium titanate powders, etc., are employed, and especially strontium titanate powders are preferable. Otherwise, the fluidity applying agent such as titanium oxide powders, aluminum oxide powders, for example, is employed, and especially the hydrophobic fluidity applying agent is preferable. The aggregation preventing agent, or the conductivity applying agent such as carbon black powders, zinc oxide powders, antimonyoxide powders, tin oxide powders, for example, or the development improving agent such as white fine grains and black fine grains with opposite polarities may be employed by a small amount.

If the toner of the present invention is employed as the binary system developer, such toner is mixed with the carrier. In this case, it is preferable that a mixed ratio of the toner and the carrier should be set to 2 to 10 wt % as the toner density. As the carrier that is available for the present invention, the well-known carrier can be employed. For example, iron powders, ferrite, magnetite, glass beads, and carriers obtained by treating the surface of the above by fluororesin, vinyl resin, silicone resin, or the like are employed.

Normally the toner of the present invention is employed as the two component developer consisting of the toner and the carrier. But the toner of the present invention may be employed as the monocomponent developer that serves as the magnetic toner in which the magnetic material is contained in the toner by an appropriate amount. In this case, such magnetic material can also perform a role of the coloring agent. In the present invention, as the magnetic material contained in the magnetic toner, there may be listed magnetite, hematite, iron oxide of ferrite; metal such as iron, cobalt, nickel, etc. or alloys of these metals and aluminum, cobalt, copper, lead, magnesium, tin, zinc, antimony, calcium, manganese, cerium, titanium, tungsten, vanadium, strontium, etc., and their mixtures.

It is preferable that the average particle size of these magnetic substances should be set to 2 μm or less, preferably about 0.1 to 0.5 μm. Preferably, an amount of the monocomponent developer contained in the magnetic toner should be set to 30 wt % to 70 wt % to the fixing resin. Also, if the non-magnetic toner is reformed electrically and magnetically as the two component developer, merely the magnetic substance may be added in the range of 0.1 wt % to 10 wt %.

As the coloring agent that is available for the toner of the present invention, any appropriate pigment or dye may be listed. As the coloring agent of the toner, for example, there are carbon black, aniline black, acetylene black, naphthol yellow, Hansa yellow, Rhodamine lake, alizarin lake, bengal, phthalocyanine blue, and indanthrene blue as the pigment. These agents are employed by a necessary and sufficient amount to maintain the optical density of the fixed image. Preferably these agents are added to the resin by 0.2 to 15 wt %.

In addition, the dye is employed for the same purpose. For example, there are azo dye, anthraquinone dye, xanthene dye, and methine dye. These dyes are added to the resin by 0.2 to 15 wt %

In order to manufacture the electrostatic charge image developing toner in the present invention, the fixing resin and the wax, the charging controlling agent, the pigment or dye as the coloring agent, magnetic powders, and other additive, as occasion demands, are mixed sufficiently by the mixer such as Henschel mixer, super mixer, or the like, then materials are mixed sufficiently by melting/kneading using the thermal melting kneading machine such as the heat roller, the kneader, the extruder, etc., and then such materials are cooled/solidified and then finely ground and classified, so that the toner whose average particle size is 6 to 10 μm can be obtained. In addition, as the case may be, the toner to which the additive is externally added can be obtained by adhering/mixing the desired additive to/into the toner by virtue of the mixer such as the Henschel mixer.

The toner of the present invention exhibits the good fixing performance particularly in the image forming apparatus that visualizes the electrostatic charge latent image, which is formed on the photosensitive body as the electrostatic charge bearing member, by using the binary system developer consisting of the toner and the carrier, then transfers the visualized toner image onto the recording medium, and then fixes the toner image by heating the recording medium that bears the toner image thereon. Thus, the heat resistance and the durability of the toner become good, and also the image forming apparatus that is capable of recording/forming the stable electrostatic toner image, in which the reduction in the developer life due to the carrier contamination caused by the toner is hard to occur, can be provided.

Examples of the present invention will be explained hereinafter, but the present invention is not limited to these examples.

At first, physical properties and the addition amount of the wax will be studied hereunder. As the hydrocarbon wax of the present invention, polyethylene waxes A, B, paraffin waxes C, D, and Fischer-Tropsch wax E were selected from the synthetic waxes and/or the natural waxes. As the comparative Example of the hydrocarbon wax, paraffin wax F and polyethylene wax G were used. The physical properties of these waxes are given in Table 1.

### EXAMPLE 1

The toner material having the compound consisting of styrene-acryl copolymer resin (weight-average molecular weight is about 240 thousand, peak molecular weight of the high molecular weight substance is about 550 thousand, and peak molecular weight of the low molecular weight substance is about 4 thousand) 85 wt %, chromeazo metal complex (product name Bontron S-34 manufactured by Orient Chemical Industry Co., Ltd.) 1 wt %, carbon black (product name: #44 manufactured by Mitsubishi Chemical Co., Ltd.) 10 wt %, and the polyethylene wax A4 wt % was mixed previously by the super mixer, then thermally melted/kneaded by the biaxial kneading machine, then ground by the jet mill, and then classified by the dry airflow classifier. Thus, the particles whose average grain size is about 9 μm were obtained.

Then, the toner was obtained by adding the hydrophobic silica (product name: Aerogel R972 manufactured by Nihon Aerogel Co., Ltd.) 0.8 wt % to the above particles, and then stirring them by the Henschel mixer to adhere the hydrophobic silica onto the surfaces of the particles. The glass transition point of the toner was 53.2° C.

### EXAMPLES 2 to 5

Respective toners were manufactured in the same way as Example 1 except that the polyethylene wax B, the paraffin waxes C, D, and the Fischer-Tropsch wax E were employed. The glass transition points of respective toners were 53.2° C., 50.8° C., 51.7° C., and 52.9° C. respectively.

### Comparative Examples 1, 2

Respective toners were manufactured in the same way as Example 1 except that the paraffin wax F and the polyethylene wax G were employed. The glass transition points of respective toners were 54.3° C. and 55.3° C. respectively.

### Comparative Example 3

The toner was manufactured in the same way as Example 1 except that, in Example 1, the styrene-acryl copolymer resin is reduced to 84 wt % and the polyethylene wax A is increased up to 5wt %. The glass transition point of the toner was 53.0° C.

Next, the method of adding the wax to the fixing resin will be studied hereunder.

### EXAMPLE 6

The resin whose maximal value of the molecular weight distribution is about 500 thousand was obtained by polymerizing the styrene 70 wt %, the methyl methacrylate 10 wt %, and the n-butyl acrylate 20 wt %. The mixture of this resin 200 g and the polyethylene wax A 40 g were put into a separable flask 3 liters and then dissolved by the xylene 1 liter, then the vapor phase was substituted with a nitrogen gas, and then this system was heated up to a boiling point (135° C. to 145° C.) of the xylene.

The solution polymerization was carried out by dropping the mixture, in which the styrene 440 g, n-butyl acrylate 65 g, and t-butylperoxy 2-ethylhexanoate 30 gas the polymerization initiator are dissolved, to spend about 2.5 hours while stirring them in the state that the circumfusion of xylene is caused. Thus, the low molecular weight polymer components were polymerized in the situation that the high molecular weight polymer and the polyethylene wax exist. After the dropping was completed, the polymer was matured for one hour while stirring at the temperature at which the xylene boils. Then, the resin HT-1 whose peak of the molecular weight distribution on the low molecular weight side is about 8 thousands was obtained by removing the xylene at the low pressure while increasing gradually the temperature of the system up to 180° C. In this resin HT-1, an amount of contained polyethylene wax was about 5.4 wt %.

Then, the toner material having the compound consisting of styrene-acryl copolymer resin HT-1 89 wt % containing the polyethylene wax A, chromeazo metal complex (product name: Bontron S-34 manufactured by Orient Chemical Co., Ltd.) 1 wt %, and carbon black (product name: #44 manufactured by Mitsubishi Chemical Co., Ltd.) 10 wt % was mixed previously by the super mixer, then thermally melted/kneaded by the biaxial kneading machine, then ground by the jet mill, and then classified by the dry airflow classifier. Thus, the particles whose average grain size is about 9 μm were obtained.

Then, the toner of the present intention was obtained by adding the hydrophobic silica (product name: Aerogel R972 manufactured by Nihon Aerogel Co., Ltd.) 0.8 wt % to the above particles, and then stirring them by the Henschel mixer to adhere the hydrophobic silica onto the surfaces of the particles. The glass transition point of the toner was 53.4° C.

### Comparative Example 4

The resin HT-2 whose peak of the molecular weight distribution on the low molecular weight side is about 9 thousands was obtained in the same method as Example 6 except that the polyethylene wax A is increased up to 50 g in Example 6. In this resin HT-2, an amount of contained polyethylene wax was about 6.6 wt %.

Then, the toner was obtained in the same way as Example 6 by using the styrene-acryl copolymer resin HT-2 containing the polyethylene wax A. The glass transition point of the toner was 53.1° C.

### Comparative Example 5

The toner that contains the particles of less than about 4 μm by about 20 number % and has the average particle size of about 8.5 μm was obtained by changing the grinding/classifying condition of the toner in Example 6. The glass transition point of the toner was 54.3° C.

The fixing performance and accelerated degradation test of the developer and the picture quality of the toners in above Examples and Comparative Examples were evaluated by following methods.

(1) Non-Offset Temperature Range

In the electrophotography system laser beam printer using the organic photoconductive photoreceptor (OPC) as the photosensitive body, the printing was executed at a printing speed of 60 sheet/min under the conditions of an OPC charged potential −650 V, a residual potential −50 V, a developing bias potential −400 V, and a developing portion contrast potential 350 V. In the developing unit, the magnetite carrier (electric resistance 4.1×10⁸Ω·cm), which is coated with the silicon resin containing the conductivity applying agent and whose weight-average particle size is about 90 μm, was used as the carrier. The developer was prepared to have the toner density of about 2.5 wt %. A developing gap (a distance between a surface of the photoreceptor and a surface of the developing roller) in the magnetic brush developing method was set to 0.8 mm. The photoreceptor and the developing roller are arranged to move in the same direction in the developing area. A peripheral speed ratio of both (developing roller/photoreceptor) was set to 3. Then, the image was produced according to the reversal system.

In the fixing unit, a roller in which an aluminum core is coated thinly with a fluororesin (tetrafluoroethylene-perfluoroalkylvinylether copolymer: PFA) tube (thickness about 40 μm) and a heater lamp is arranged at its center portion was used as the heat roller, and a roller in which the aluminum core is coated with a silicon rubber layer (thickness 7 mm) having a rubber hardness of about 30 degree and its outermost layer is coated with the PFA tube was used as the back-up roller. As the fixing conditions, a process speed is 26.7 cm/sec, outer diameters of the heat roller and the back-up roller are 60 mm, a pushing load is 50 kgf, and a width of the contact area (nip) between them is about 7 mm. While changing the control temperature of the heat roller, the offset was evaluated based on the contamination on the white paper portion of the fixed image at respective surface temperatures of the heat roller. In this case, essentially the cleaner of the nomex paper winding type, which is impregnated with the silicon oil, is fitted to the heat roller. When the offset is to be evaluated, the cleaner was removed and then the image was recorded on the thick paper (thickness about 200 μm) and the thin paper (thickness about 100 μm) in the silicon-oil less state. The low-temperature offset was evaluated based on the former whereas the high-temperature offset was evaluated based on the latter.

(2) Fixing Strength

The surface temperature of the heat roller in the above fixing unit is set to 175° C., and the full black image having a 1-inch square and the line drawing depicted by 1-ON and 4-OFF intervals of the laser beam are recorded on the thick paper (thickness about 200 μm). Thus, the fixing strength of the image was evaluated by applying the tape peeling test and the rubbing test to such full black image and such line drawing respectively.

In the tape peeling test, the Scotch (trademark) mending tape 810 was pasted onto the full black image, then the image density was measured by the reflection densitometer (RD-914 manufactured by Macbeth Co., Ltd.) before and after the tape is peeled off, and then the tape peeling strength was calculated based on “Tape peeling strength (%)=(reflection density of the full black image after the tape is peeled off/reflection density of the full black image before the tape is peeled off)×100”.

In the rubbing test, the rubbing strength (%) was derived by rubbing the line drawing with the Wattmann filter paper at the load of 200 gf, then a degree of contamination of the filter paper was evaluated by the brightness meter, and then calculating a ratio of the light reflection factors as the Hunter's value (%).

(3) Accelerated Degradation Test of the Developer

The magnetite carrier on the surface of which the resin is coated by an appropriate amount and which has a particle size of about 90 μm was employed. The mixed rate of the toner and the carrier was set to about 2.5 wt %. The developer of about 1 kg was prepared by the mixer. Then, the developer was filled into the small one roller developer of the magnetic roller fixed type, then the developer was stirred while setting a roller diameter of about 30 mm, a roller peripheral speed of about 1400 mm/sec, and a regulating gap about 0.6 mm without the supply of the toner during the stirring, then the developer is held appropriately while controlling the atmospheric temperature to the temperature that is lower than the glass transition point of the toner and is higher than 45° C. until 24 hours has lapsed after the start of the stirring, and the amount of maximum change of the quantity of charge of the toner and the amount of contamination of the carrier by the toner were examined by sampling the developer at every 4 hours, for example.

(4) Evaluation of the Picture Quality

In the above electrophotography system laser beam printer, the surface temperature of the heat roller is set to 185° C., then the silicon oil is supplied to the heat roller, and then the picture quality of the printed images recorded on the standard paper (thickness about 100 μm) was evaluated with the eye up to about 200 thousand pages.

Evaluation results of above items of the toner are shown in Tables 1 and 2.

TABLE 1

| | Properties of the wax added to the toner | | |
|---|---|---|---|
| | | | Melting |
| | Hydrocarbon wax type | | point |
| | (wt % of the wax in a resin total | Crystallinity | (° C.) in |
| | amount) | (%) | DSC |
| Example 1 | Polyethylene wax A | 83 | 82 |
| | (melt mixed into resin about 4.5) | | |
| Example 2 | Polyethylene wax B | 85 | 83 |
| | (melt mixed into resin about 4.5) | | |
| Example 3 | Paraffin wax C | 86 | 64 |
| | (melt mixed into resin about 4.5) | | |
| Example 4 | Paraffin wax D | 93 | 67 |
| | (melt mixed into resin about 4.5) | | |
| Example 5 | Fischer-Tropsch wax E | 90 | 80 |
| | (melt mixed into resin about 4.5) | | |
| Comparative | Paraffin wax F | 95 | 70 |
| Example 1 | (melt mixed into resin about 4.5) | | |
| Comparative | Polyethylene wax G | 94 | 93 |
| Example 2 | (melt mixed into resin about 4.5) | | |
| Comparative | Polyethylene wax A | 83 | 82 |
| Example 3 | (melt mixed into resin about 5.6) | | |
| Example 6 | Polyethylene wax A | 83 | 82 |
| | (mixed into resin about 5.4 | | |
| | by concomitant polymerization) | | |
| Comparative | Polyethylene wax A | 83 | 82 |
| Example 4 | (mixed into resin by about 6.6 | | |
| | by concomitant polymerization) | | |
| Comparative | Polyethylene wax A | 83 | 82 |
| Example 5 | (mixed into resin by about 5.4 | | |
| | by concomitant polymerization) | | |

TABLE 2
The toner fixing performance and change in physical
properties by the accelerated degradatior test

| | | | | | | pictures |
|---|---|---|---|---|---|---|
| | | | | | | Quality |
| | | | | | | of |
| | | | | | | the |
| | | | | | | laser |
| | | | | | | printer |
| | | | | Amount of | Amount | after |
| | | | | maximum | of | the |
| | | | | change of | Carrier | print- |
| | Non- | | | the | con- | ing |
| | offset | | | quanity | tamina- | of |
| | temper- | | | of charge | tion | 200 |
| | ature | Tape | Rubbing | of the | by the | thou- |
| | range | peeling | strength | toner | toner | sand |
| | (° C.) | strength | (%) | (μC/g) | (wt %) | pages |
| Example 1 | 165->220 | 84.8 | 83.3 | 7.9 | 0.131 | Good |
| Example 2 | 165->220 | 84.5 | 82.1 | 6.7 | 0.118 | Good |
| Example 3 | 165->220 | 85.1 | 85.3 | 6.5 | 0.116 | Good |
| Example 4 | 165->220 | 82.5 | 82.2 | 7.0 | 0.115 | Good |
| Example 5 | 165->220 | 83.2 | 82.0 | 9.3 | 0.113 | Good |
| Compara- | 165->220 | 78.2 | 75.2 | 9.5 | 0.096 | Good |
| tive | | (Bad) | (Bad) | | | |
| Example 1 | | | | | | |
| Compara- | 165->220 | 78.5 | 72.0 | 8.4 | 0.040 | Good |
| tive | | (Bad) | (Bad) | | | |
| Example 2 | | | | | | |
| Compara- | 160->220 | 84.5 | 86.4 | 21.1 | 0.192 | Bad |
| tive | | | | | | |
| Example 3 | | | | | | |
| Example 6 | 165->220 | 81.4 | 86.0 | 14.6 | 0.154 | Good |
| Compara- | 160->220 | 98.0 | 86.1 | 20.5 | 0.164 | Bad |
| tive | | | | | | |
| Example 4 | | | | | | |
| Compara- | 165->220 | 84.2 | 82.3 | 10.9 | 0.415 | Bad |
| tive | | | | | | |
| Example 5 | | | | | | |

As apparent from the evaluation results in Tables 1 and 2, in the toner shown in Examples 1 to 6 according to the present invention, the non-offset temperature range was wide, and the tape peeling strength and the rubbing strength as the fixing strength at the fixing temperature of 175° C. exceeded 80%. Thus, the fixing strength that is practically available could be implemented. Also, both the amount of the maximum change of the quantity of charge of the toner in the accelerated degradation test of the developer and the amount of the carrier contamination due to the toner were small. Thus, if the toner of the present invention was applied to the above laser beam printer to repeat the continuous printing by about 200 thousand times, the good picture quality could be obtained and the reduction in the developer life was not caused.

In contrast, in the toners in Comparative Examples 1 and 2, it was found that the non-offset temperature range is wide but the fixing strength is below 80% and is not sufficient, and thus it is difficult to put such toners into practical use. In the toners in Comparative Examples 3 and 4, it was found that the amount of the maximum change of the quantity of charge of the toner in the accelerated degradation test of the developer is larger than 20 μC/g and thus the picture quality is lowered at the continuous printing up to about 10 thousand pages if such toner is applied to the above laser beam printer. Similarly, in the toner in Comparative Example 5, it was found that the amount of the carrier contamination by the toner in the accelerated degradation test of the developer is larger than 0.4 wt % and thus the picture quality is lowered at the continuous printing up to about 50 thousand pages.

A configuration of the above laser beam printer will be explained with reference to FIG. 1 hereunder. A reference 1 is a main body of the basic apparatus. The main body 1 of the basic apparatus has a printer portion 3 that can be pulled out from an apparatus frame 2. A reference 4 is a photosensitive drum on which the toner image is recorded/formed by the well-known electrophotography process. The photosensitive drum 4 is supported by the supporting axis to rotate at a predetermined speed in the direction indicated by an arrow a.

A charger 5 is arranged to oppose to a surface of the photosensitive drum 4, and charges uniformly the surface of the photosensitive drum 4 that is passed to oppose to this charger 5. A laser beam 6 exposes the surface of the photosensitive drum 4, which has been charged uniformly, and forms the electrostatic charge latent image on the surface of the photosensitive drum 4 in compliance with a printing information signal that is supplied from an information processing equipment.

A developing unit 7 is arranged to oppose to the surface of the photosensitive drum 4 on which the electrostatic charge latent image is formed. This developing unit 7 has a developing function that can form the toner image by depositing the above toner onto the surface of the photosensitive drum 4 by virtue of an electrostatic force of the electrostatic charge latent image.

A cassette 8 contains sheet-like recording medium (paper) 9, on which the toner image is transferred and fixed to print the image, in its piled state. A paper feeding roller mechanism 10 constituting a part of the recording member carrying means picks up the paper 9 from the cassette 8 and feeds such paper 9 to the photosensitive drum 4.

The paper 9 being fed from the paper feeding roller mechanism 10 contacts to the surface of the photosensitive drum 4 to transfer the toner image onto the surface. A transferring unit 11 applies the charge, which has the opposite polarity to the toner image, onto a back surface of the paper 9, which is brought into contact with the surface of the photosensitive drum 4, to generate the electrostatic force that is used to transfer the toner image, which is formed on the surface of the photosensitive drum 4, onto the paper 9.

A carrying belt 12 constituting another part of the paper carrying means feeds the paper 9, on which the toner image is transferred, to a contact type thermal fixing unit 13 as the fixing means. A pair of fixing rollers 14 consisting of a heat roller 14a and a back-up roller 14b, which are brought into contact with each other by the pressure, heat the paper 9 and apply the pressure to the paper 9 to fix the toner image on the surface of the paper 9.

The paper being sent out from the fixing unit 13 is discharged to a discharging portion 16 or a discharging portion 17 in response to the position of a paper carrying path switching member 15. Otherwise, the paper being sent out from the fixing unit 13 is carried to the discharging portion 17 side in the middle, then is carried to the both-side printing paper feeding path 20 side at a predetermined timing, and then the printing paper whose printing on the front surface has been completed is supplied again to the printer portion 3 to apply the printing on the back surface of the paper.

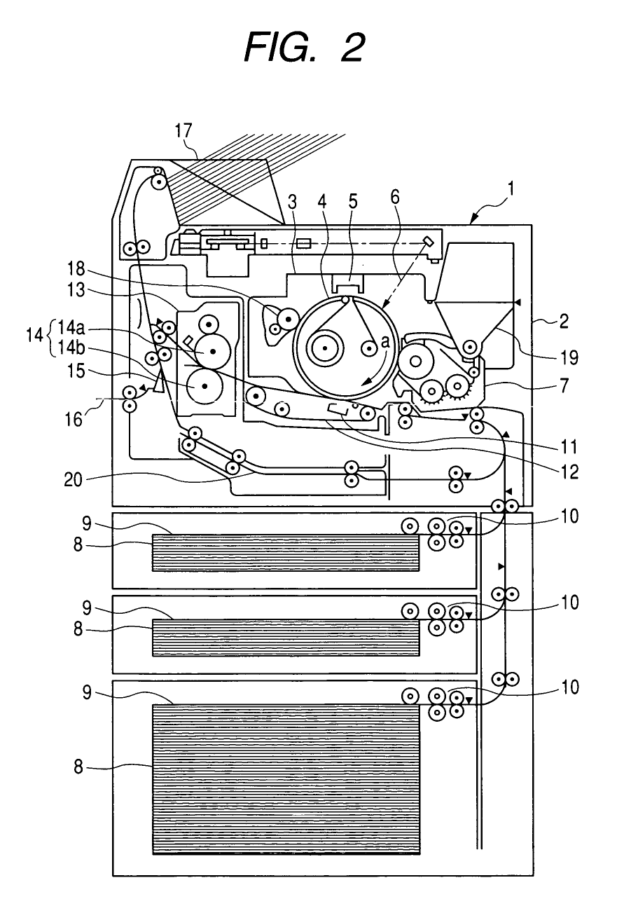

In this case, in FIG. 1, a reference 18 is a cleaning unit that removes the toner and the foreign matters such as the paper powder, which still remain on the surface of the photosensitive drum 4 after the paper 9 passes through the transferring unit 11, from the surface of the photosensitive drum 4. A reference 19 is a toner supplying unit that supplies the toner to the developing unit 7 as the case may be. In this case, the laser beam printer into which the developing unit having one developing roller is installed is shown in FIG. 2, but the developing unit having a plurality of, e.g., more than two developing rollers is installed may be employed. Also, the laser beam printer into which the center feed type developing unit having the developing roller, which is rotated in the same direction as the photosensitive drum, and the developing roller, which is rotated in the opposite direction to the photosensitive drum, may be employed.

As described above, according to the present invention, there can be provided a toner, which is excellent in the heat resistance and the durability and is capable of reducing an energy required for the fixing, and an image forming apparatus using the same.

What is claimed is:

1. An electrostatic charge image developing developer, comprising:
a carrier; and
an electrostatic charge image developing toner including a fixing resin and a hydrocarbon wax whose crystallinity is less than 93%, the electrostatic charge image developing toner being mixed into the carrier;
wherein an amount of maximum change in a quantity of charge of the electrostatic charge image developing toner is smaller than 20 μC/g, and an amount of contamination of a carrier due to the electrostatic charge image developing toner is less than 0.4 wt %, when the electrostatic charge image developing developer is stirred for 24 hours at an atmospheric temperature that is lower than a glass transition point of the toner and is higher than 45° C.

2. The electrostatic charge image developing developer according to claim 1,
wherein a melting point of the hydrocarbon wax, which is defined as a maximum peak of the absorbed heat quantity curve at a time of temperature rise, is set in a range of 50° C. to 120° C. in a DSC curve measured by the differential scanning calorimeter.

3. The electrostatic charge image developing developer according to claim 1, wherein the toner contains at least a vinyl copolymer, which is polymerized in existence of the hydrocarbon wax, as the fixing resin.

4. An image forming apparatus comprising:
an electrostatic charge bearing member that bears an electrostatic charge latent image thereon;
a developing unit for supplying an electrostatic charge image developing developer to the electrostatic charge bearing member to visualize the electrostatic charge latent image as a toner image;
a transferring unit for transferring the toner image formed on the electrostatic charge bearing member onto a recording medium; and
a fixing unit for fixing the toner image onto the recording medium by applying at least a heat to the recording medium that bears the toner image;
wherein the electrostatic charge image developing developer is formed by mixing an electrostatic charge image developing toner that contains at least a fixing resin and a hydrocarbon wax whose crystallinity is less than 93% into a carrier;
when the electrostatic charge image developing developer is stirred for 24 hours at an atmospheric temperature that is lower than a glass transition point of the toner and is higher than 45° C., an amount of maximum change in a quantity of charge of the electrostatic charge image developing toner is smaller than 20 μC/g and an amount of contamination of the carrier due to the electrostatic charge image developing toner less than 0.4 wt %.

5. The image forming apparatus according to claim 4, wherein the fixing unit is a contact-type thermal fixing unit.
